(19) United States
(12) Patent Application Publication
(10) Pub. No.: US 2013/0230282 A1
(43) Pub. Date: Sep. 5, 2013

(54) LIGHT GUIDING DEVICE AND LIGHT GUIDING METHOD

(71) Applicant: FUJI ELECTRIC CO., LTD., Kawasaki-shi (JP)

(72) Inventor: Masanori OTO, Yokohama-city (JP)

(73) Assignee: FUJI ELECTRIC CO., LTD., Kawasaki-shi (JP)

(21) Appl. No.: 13/861,555

(22) Filed: Apr. 12, 2013

Related U.S. Application Data
(63) Continuation of application No. PCT/JP2012/002436, filed on Apr. 6, 2012.

(30) Foreign Application Priority Data
Jun. 16, 2011 (JP) 2011-133916

(51) Int. Cl. G02B 6/26

(52) U.S. Cl. CPC G02B 6/26
USPC 385/50

(57) ABSTRACT

In aspects of the invention, photonic crystal fiber and a GI fiber form an emission portion of a first single-mode optical fiber. Specifically, in some aspects of the invention, the photonic crystal fiber is connected to an emission-side end face of the first single-mode optical fiber. The GI fiber can connected to an emission-side end face of the photonic crystal fiber. The refractive index of the GI fiber in the direction in which light is concentrated changes in the radial direction.

### CROSS-REFERENCE TO RELATED APPLICATIONS

This application is a continuation of International Application No. PCT/JP2012/002436, filed on Apr. 6, 2012, which is based on and claims priority to Japanese Patent Application No. JP 2011-133916, filed on 16 Jun. 2011. The disclosure of the Japanese priority application and the PCT application in their entirety, including the drawings, claims, and the specification thereof, are incorporated herein by reference.

### BACKGROUND

1. Field of the Invention

This invention relates to light guiding devices and light guiding methods.

2. Related Art

Previously, optical fibers had been used only with light in the near-infrared region. However, advances in optical fiber technology in recent years have resulted in expansion of the range of use, from the ultraviolet to the mid-infrared. For example, Japanese Patent Application Laid-open No. 2005-62850 (also referred to herein as “Patent Reference 1”) indicates that light at different wavelengths is guided using a photonic crystal fiber.

A Japanese Translation of PCT Application No. 2009-522605 (also referred to herein as “Patent Reference 2”) indicates that light generated by a plurality of light sources is guided by different optical fibers, and is then concentrated by a lens.

Japanese Patent Application Laid-open No. 2004-61830 (also referred to herein as “Patent Reference 3”) indicates that a single-mode optical fiber is connected to an optical element via a photonic crystal fiber.

Using an optical fiber, the range of light irradiation can be narrowed, and therefore an optical system can be made compact. In order to guide light at different wavelengths using an optical fiber while exploiting this feature, it is necessary to emit light at different wavelengths with substantially the same mode field diameter and having a single mode, in a collimated state, from the optical fiber.

Thus, as described above, there is a need in the art for an improved light guiding device.

### SUMMARY OF THE INVENTION

Embodiments of the invention address this and other needs. Some embodiments emit from an optical fiber of light at different wavelengths in a collimated state, with substantially the same mode field diameter and having a single mode.

In some embodiments, a light guiding device includes a first single-mode optical fiber, a photonic crystal fiber, and a graded index fiber. The photonic crystal fiber is connected to the emission-side end face of the first single-mode optical fiber. The graded index fiber is connected to the emission-side end face of the photonic crystal fiber. The refractive index of the graded index fiber in a direction in which light is concentrated changes in a radial direction.

By way of this light guiding device, a plurality of light rays at different wavelengths pass through the first single-mode optical fiber, the photonic crystal fiber, and the graded index fiber, and are emitted. The plurality of light rays have substantially the same mode field diameter and have a single mode as a result of passing through the photonic crystal fiber. After passing through the photonic crystal fiber, the plurality of light rays further pass through the graded index fiber, and are collimated.

In some embodiments, first a light guiding device is prepared, including a first single-mode optical fiber, a photonic crystal fiber, and a graded index fiber. In this light guiding device, the photonic crystal fiber is connected to the emission-side end face of the first single-mode optical fiber. The graded index fiber is connected to the emission-side end face of the photonic crystal fiber. The refractive index of the graded index fiber in the direction in which light is concentrated changes in the radial direction. A plurality of light rays with different wavelengths are guided by the first single-mode optical fiber. The plurality of light rays are then subjected to single-mode conversion, and the mode field diameter is made uniform, using the photonic crystal fiber. Further, chromatic aberration correction of the plurality of light rays is performed using the graded index fiber. Then, the plurality of light rays are emitted from the graded index fiber.

By way of some embodiments, light at different wavelengths from an optical fiber can be emitted in a collimated state, with substantially the same mode field diameter and having a single mode.

### BRIEF DESCRIPTION OF THE DRAWINGS

Certain features and advantageous results will become clear through the preferred embodiments described below, and the attached drawings.

FIG. 1 shows the configuration of the light guiding device of a first embodiment of the invention;

FIG. 2 is a cross-sectional view showing the configuration of a photonic crystal fiber;

FIG. 3 shows the configuration of the light guiding device of a second embodiment of the invention;

FIG. 4 shows the configuration of the light guiding device of a third embodiment of the invention;

FIG. 5 shows the configuration of the light guiding device of a fourth embodiment of the invention;

FIG. 6 shows the configuration of the optical device of a fifth embodiment of the invention;

FIG. 7 shows the configuration of the optical device of a sixth embodiment of the invention; and

FIG. 8 is a graph showing the collimator characteristic of a light guiding device of an example.

### DETAILED DESCRIPTION

Below, embodiments of the invention are explained using the drawings. In general, in the drawings, the same symbols are assigned to the same constituent elements, and explanations are omitted as appropriate.

### FIRST EMBODIMENT

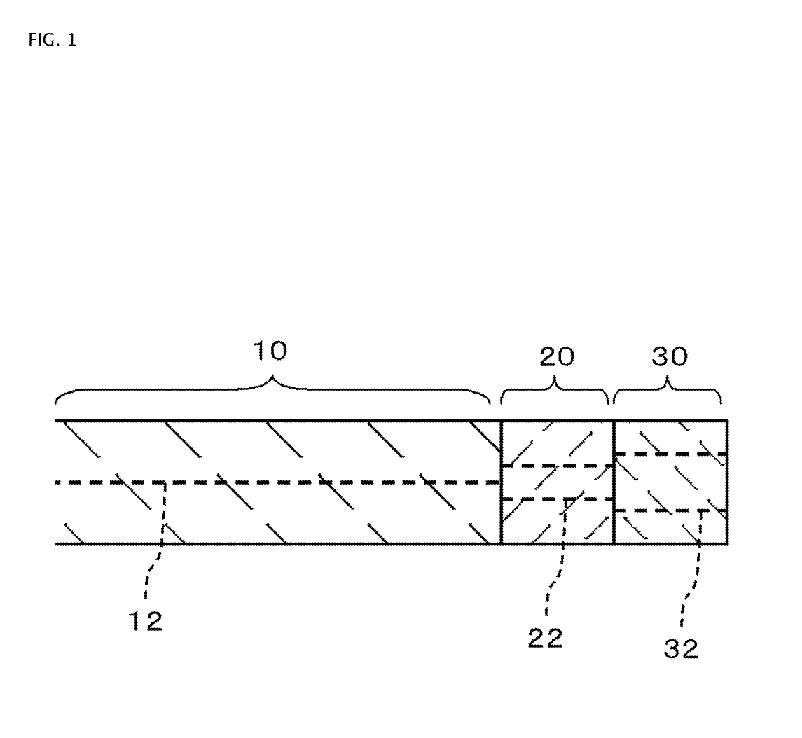

FIG. 1 shows the configuration of the light guiding device of a first embodiment. This light guiding device comprises a first single-mode optical fiber 10, a photonic crystal fiber 20, and a graded index fiber (hereafter called a “GI fiber”) 30. The first single-mode optical fiber 10 is a fiber to guide light.

The photonic crystal fiber 20 and the GI fiber 30 form the emission portion of the first single-mode optical fiber 10. Specifically, the photonic crystal fiber 20 is connected to the emission-side end face of the first single-mode optical fiber 10. The GI fiber 30 is connected to the emission-side end face of the photonic crystal fiber 20. The refractive index of the GI fiber 30 in the direction in which light is concentrated changes in the radial direction. The lengths of the photonic crystal fiber 20 and the GI fiber 30 are designed such that the photonic crystal fiber 20 and the GI fiber 30 are accommodated within ferrules or other mounting jigs. For example, the length of the photonic crystal fiber 20 is 0.5 mm or greater and 5 mm or less, and the length of the GI fiber is 0.1 mm or greater and 1 mm or less.

The first single-mode optical fiber 10 is for example formed from silica glass. The first single-mode optical fiber 10 has a core 12. The core 12 is formed by doping the body of the first single-mode optical fiber 10 with an impurity, such as Ge. The photonic crystal fiber 20 has a core 22. The GI fiber 30 has a core 32. The cores 12, 22, and 32 are all regions in which light is guided.

The refractive index of the core 32 of the GI fiber 30 changes in the radial direction. This direction of change in the refractive index is the direction in which light passing through the core 32 is concentrated. For example, the impurities in the core 32 are decreased from the center toward the outside. Specifically, the impurity concentration is highest at the center of the core 32, and is inversely proportional to the square of the distance from the center. When the GI fiber 30 is formed from silica glass, the impurity with which the core 32 is doped is for example Ge.

The portion connecting the first single-mode optical fiber 10 and the photonic crystal fiber 20 effects connection by for example fusion. However, the first single-mode fiber 10 and the photonic crystal fiber 20 may also be connected using an adhesive. Similarly, the photonic crystal fiber 20 and the GI fiber 30 are connected by for example fusion, but may be connected using an adhesive as well.

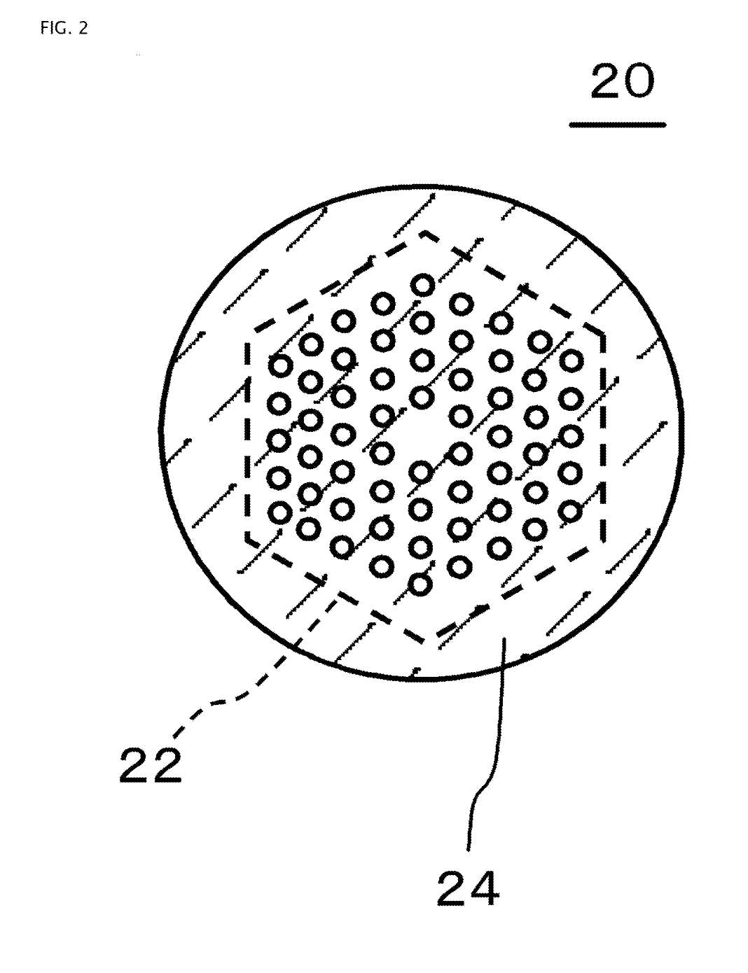

FIG. 2 is a cross-sectional view showing the configuration of the photonic crystal fiber 20. The photonic crystal fiber 20 has a plurality of holes 24. The holes 24 are arranged regularly within the core 22. That is, the region in which the holes 24 are arranged is the core 22. The plurality of holes 24 all have substantially the same diameter, and are arranged at the same intervals within the core 22. However, holes 24 are not arranged at the center portion of the core 22. That is, a hole 24 is absent in the center portion of the arrangement of holes 24. On the periphery of this region in which a hole 24 is absent, three or more columns of holes 24 are arranged. In the example shown, the holes 24 are arranged in a regular hexagon. By this means, when passing through the photonic crystal fiber 20, a plurality of light rays at different wavelengths have substantially the same mode field diameter and have a single mode.

Next, action and advantageous results of this embodiment are explained. The light guiding device shown in FIG. 1 is used for example in a multi-wavelength light source device to guide a plurality of light rays at different wavelengths which have been emitted from a laser light source. The plurality of laser light rays may be made incident simultaneously on the light guiding device, or may be made incident with different timings. The laser light wavelengths are for example 490 nm or greater and 630 nm or less.

Of the first single-mode optical fiber 10, the end portion on the side on which the photonic crystal fiber 20 is provided is positioned in the region to which light is to be guided, for example, above a sample. And, light is made incident on the first single-mode optical fiber 10 at the end portion on the side opposite the photonic crystal fiber 20.

Light guided by the first single-mode optical fiber 10 passes through the photonic crystal fiber 20 and the GI fiber 30 and is emitted. When passing through the photonic crystal fiber 20, the plurality of light rays at different wavelengths come to have substantially the same mode field diameter and have a single mode. Light which has passed through the photonic crystal fiber 20 further passes through the GI fiber 30, and is collimated.

Hence, by means of this embodiment, light from a single optical fiber at different wavelengths can be emitted in a collimated state, with substantially the same mode field diameter and having a single mode. By using the light guiding device of this embodiment, the optical system necessary for light guiding is decreased, and a multi-wavelength light source device can be made compact.

The emission-side end face of the GI fiber 30 may be treated with an anti-reflection coating. An anti-reflection coating is for example a thin film with refractive index lower than that of the GI fiber 30. By forming an anti-reflection coating, when light is emitted from the GI fiber 30, reflection of light at the interface between the GI fiber 30 and the outside can be suppressed.

### SECOND EMBODIMENT

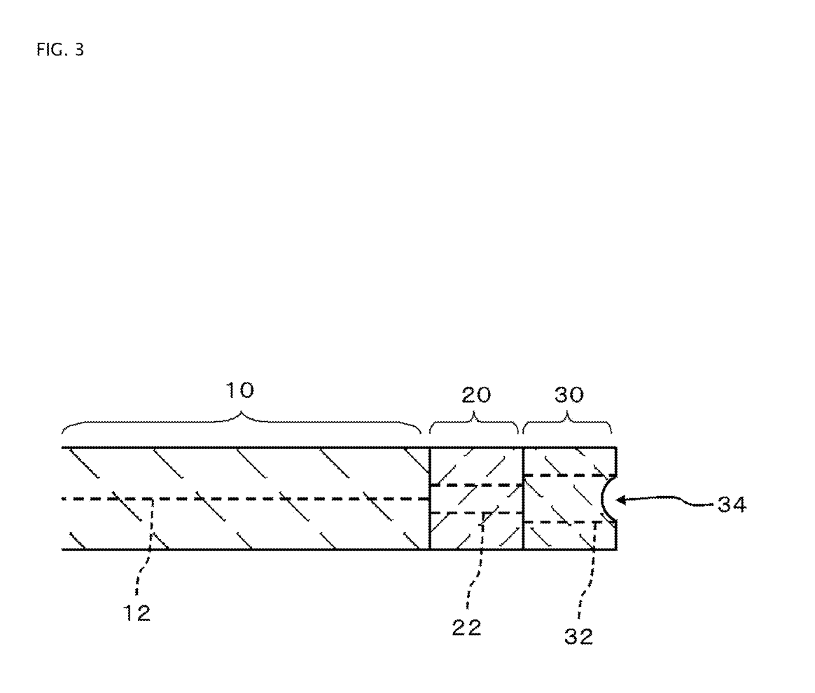

FIG. 3 shows the configuration of the light guiding device of a second embodiment. This light guiding device has the same configuration as the light guiding device of the first embodiment, except for the fact that the GI fiber 30 has a concave portion 34.

The concave portion 34 is provided in the emission-side end face of the GI fiber 30. The concave portion 34 has a concave lens shape, and is provided at least over the entirety of the end face of the core 32. The concave portion 34 has the function of correcting chromatic aberration in light emitted from the GI fiber 30.

The concave portion 34 may be formed by polishing, or may be formed by etching. The impurity concentration in the core 32 is highest at the center of the core 32 and falls in moving toward the outside. The strength of the GI fiber 30 is inversely proportional to the impurity concentration. Hence, if the end face of the core 32 is polished or etched, the core 32 becomes deepest at the center, and becomes shallower toward the outside. Further, the impurity concentration in the core 32 is inversely proportional to the square of the distance from the center. Hence, the concave portion 34 has a concave lens shape. When etching the core 32, for example an HF system solution is used as the etching liquid.

When the concave portion 34 is formed by polishing, only minimal equipment investments are necessary. Moreover, a plurality of light guiding devices can be treated simultaneously, so that productivity is improved. When on the other hand the concave portion 34 is formed by etching, the shape of the concave portion 34 during fabrication can be monitored, so that the precision of fabrication of the concave portion 34 is improved.

By way of this embodiment also, advantageous results similar to those of the first embodiment can be obtained. Further, a concave portion 34 with a concave lens shape is formed in the emission-side end face of the GI fiber 30. Hence even if a lens is not provided on the outside, when a plurality of light rays at different wavelengths are emitted from the GI fiber 30, the occurrence of chromatic aberration can be suppressed.

### THIRD EMBODIMENT

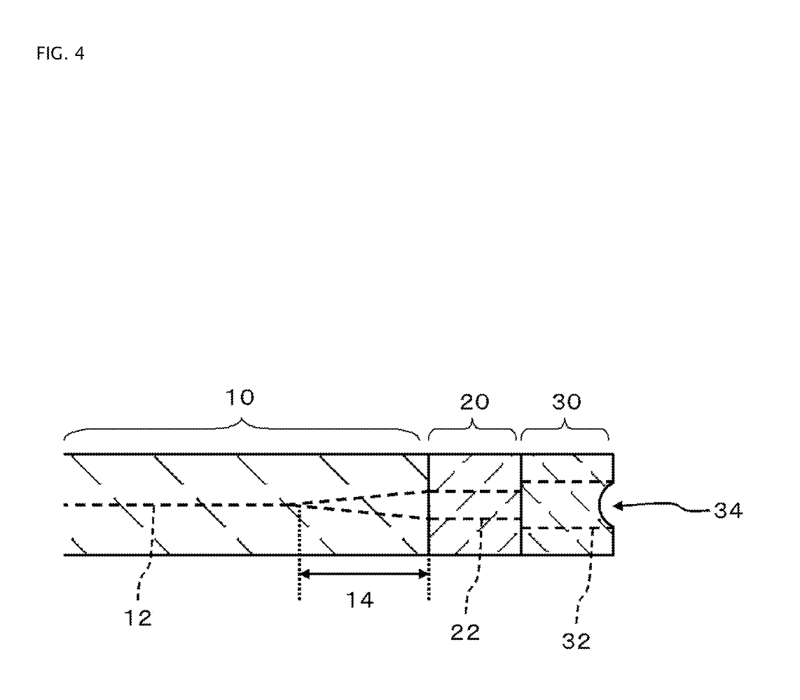

FIG. 4 shows the configuration of the light guiding device of a third embodiment. The light guiding device of this embodiment has the same configuration as the light guiding device of the second embodiment, except for the structure of the end portion 14 of the first single-mode optical fiber 10.

In this embodiment, the core 12 of the first single-mode optical fiber 10 gradually expands at the end portion 14. Such a structure is obtained by heat treatment of the end portion 14 (TEC (Thermally Expanded Core) treatment), causing thermal diffusion of impurities in the core 12. The mode field diameter at the face joined with the photonic crystal fiber 20 of the first single-mode optical fiber 10 is the same as the mode field diameter of the photonic crystal fiber 20. In this embodiment, a concave portion 34 may not be provided.

By means of this embodiment also, advantageous results similar to those of the second embodiment can be obtained. Further, the core 12 of the first single-mode optical fiber 10 expands gradually at the end portion 14. At the face joined with the photonic crystal fiber 20, the core 12 has the same diameter as the core 22 of the photonic crystal fiber 20. Hence at the face joining the first single-mode optical fiber 10 and the photonic crystal fiber 20, the occurrence of optical losses arising from mismatches of mode field diameters can be suppressed.

### FOURTH EMBODIMENT

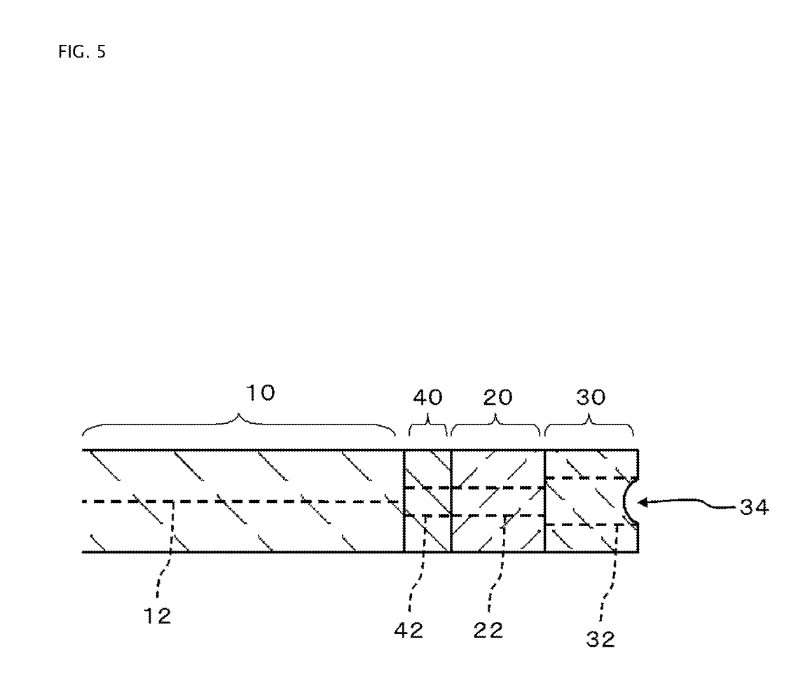

FIG. 5 shows the configuration of the light guiding device of a fourth embodiment. The light guiding device of this embodiment has the same configuration as the light guiding device of the second embodiment, except for the fact of comprising a second single-mode fiber 40.

The second single-mode fiber 40 is provided between the first single-mode optical fiber 10 and the photonic crystal fiber 20. The second single-mode fiber 40 is a low-N.A. (Numerical Aperture) fiber. That is, the diameter of the core 42 of the second single-mode fiber 40 is larger than that of the core 12 of the first single-mode optical fiber 10. That is, the mode field diameter of the second single-mode fiber 40 is greater than the mode field diameter of the first single-mode optical fiber 10. However, the mode field diameter of the second single-mode fiber 40 is equal to or smaller than the mode field diameter of the photonic crystal fiber 20. Further, the difference in refractive indices of the core 42 and the cladding portion of the second single-mode fiber 40 is smaller than the difference in refractive indices of the core 12 and cladding portion of the first single-mode optical fiber 10. In the first embodiment, a second single-mode fiber 40 may be provided.

By means of this embodiment also, advantageous results similar to those of the second embodiment can be obtained. Further, a second single-mode fiber 40 is positioned between the first single-mode optical fiber 10 and the photonic crystal fiber 20. Hence the mode field diameter of light guided by the first single-mode optical fiber 10 expands during propagation in the second single-mode fiber 40, and thereafter is incident on the photonic crystal fiber 20. Hence at the face joining the first single-mode fiber 10 and the photonic crystal fiber 20, the occurrence of optical losses arising from mismatches of mode field diameters can be suppressed.

### FIFTH EMBODIMENT

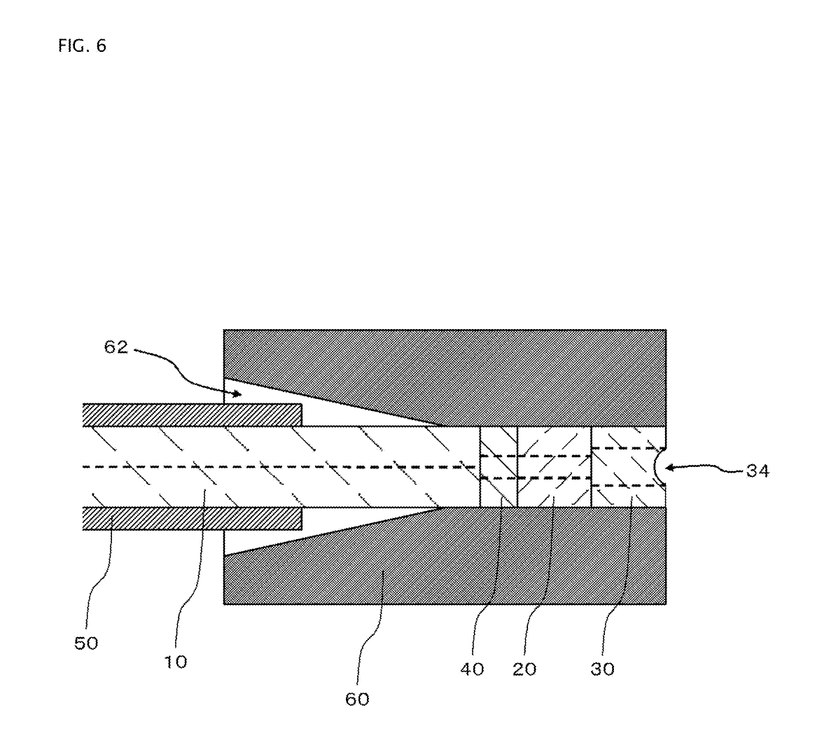

FIG. 6 shows the configuration of the optical device of a fifth embodiment. The optical device of this embodiment mounts the emission-side end portion of a light guiding device according to any one of the first to fourth embodiments on a ferrule 60. In the example shown in the figure, the light guiding device of the fourth embodiment is shown.

Specifically, the first single-mode optical fiber 10 is covered by a covering member 50. However, of the first single-mode optical fiber 10, the covering member 50 is not provided on the emission-side end portion. The emission-side end portion of the first single-mode optical fiber 10, together with the end portion of the covering member 50, is inserted into an insertion opening 62 of the ferrule 60. And, the end portion of the first single-mode optical fiber 10, the second single-mode fiber 40, the photonic crystal fiber 20, and the GI fiber 30 are held by the ferrule 60.

### SIXTH EMBODIMENT

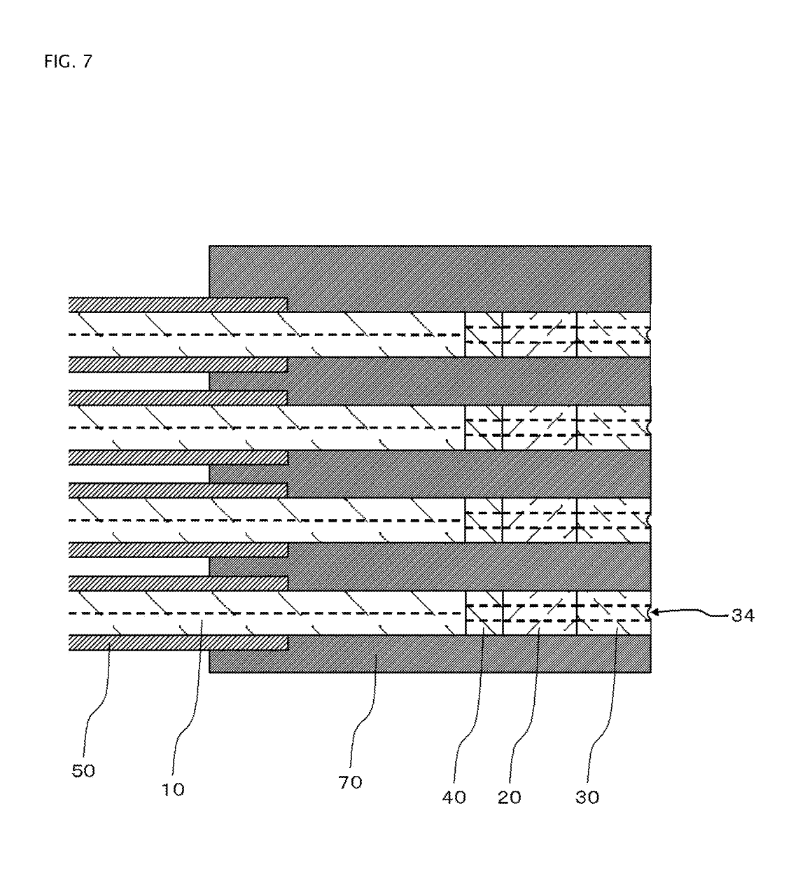

FIG. 7 shows the configuration of the optical device of a sixth embodiment. In the optical device of this embodiment, a plurality of the light guiding devices according to any one of the first to the fourth embodiments are held by a holding member 70. In the example shown in the figure, light guiding devices of the fourth embodiment are shown.

A plurality of V-shape grooves are provided in parallel in the holding member 70. The end portions of first single-mode optical fibers 10, second single-mode fibers 40, photonic crystal fibers 20, and GI fibers 30 are fitted into the grooves. By this means, the holding member 70 can hold a plurality of light guiding devices in parallel.

### EXAMPLE

The light guiding device shown in FIG. 4 was fabricated. A visible light fiber with a cutoff wavelength of 430 nm was used as the first single-mode optical fiber 10. The photonic crystal fiber 20 used had a mode field diameter of 15 μm. The GI fiber 30 used had a core of 62.5 nm.

First, the end portion 14 of the first single-mode optical fiber 10 was subjected to heat treatment. Then, the first single-mode optical fiber 10 and the photonic crystal fiber 20 were heat-fused. Further, the photonic crystal fiber 20 and the GI fiber 30 were heat-fused. Thereafter a concave portion 34 was formed by HF etching of the GI fiber 30.

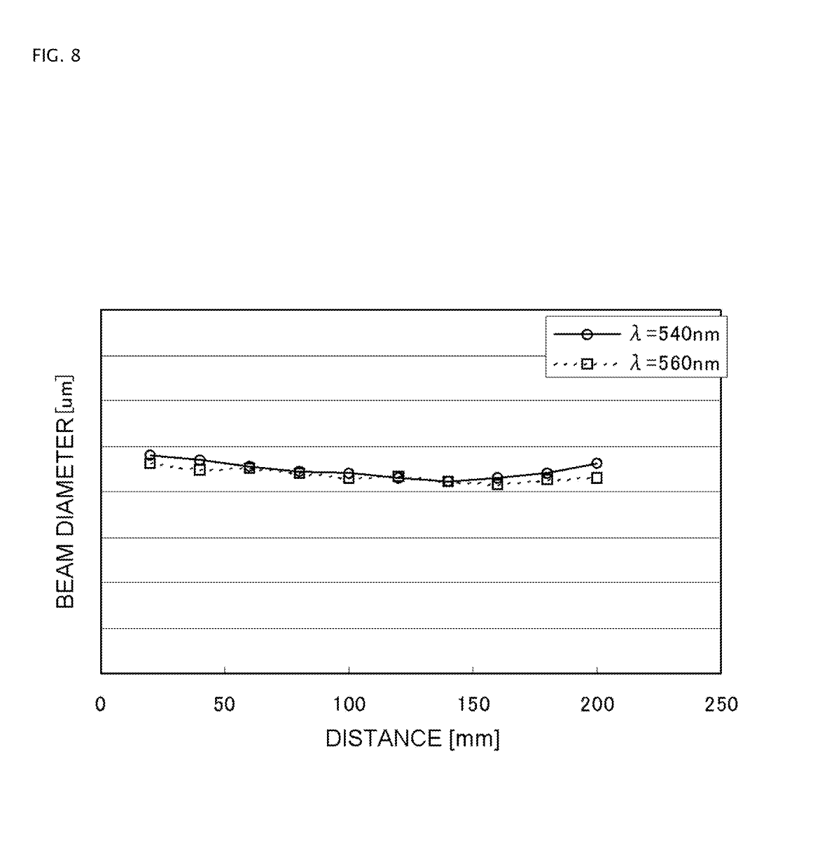

FIG. 8 shows collimator characteristics of the light guiding device of the example. The vertical axis indicates the beam diameter of emitted light, and the horizontal axis indicates the distance from the concave portion 34. As shown in the figure, satisfactory collimation characteristics were obtained both for light of wavelength 540 nm and for light of wavelength 560 nm. The beam diameters were substantially the same at these two wavelengths.

In the above, embodiments of the invention have been explained referring to the drawings, but the embodiments are merely examples of the invention, and various configurations other than those described above can be adopted.

Examples of specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the above description, specific details are set forth in order to provide a thorough understanding of embodiments of the invention. Embodiments of the invention may be practiced without some or all of these specific details. Further, portions of different embodiments and/or drawings can be combined, as would be understood by one of skill in the art.

What is claimed is:

1. A light guiding device, comprising:
a first single-mode optical fiber;
a photonic crystal fiber, connected to an emission-side end face of the first single-mode optical fiber; and
a graded index fiber, which is connected to an emission-side end face of the photonic crystal fiber, and the refractive index of which in a direction of light concentration changes in a radial direction.

2. The light guiding device according to claim 1, wherein the graded index fiber has a lens-shape concave portion in an emission-side end face thereof.

3. The light guiding device according to claim 1, wherein a mode field diameter of an emission-side end portion of the first single-mode optical fiber is larger than another portion.

4. The light guiding device according to claim 2, wherein a mode field diameter of an emission-side end portion of the first single-mode optical fiber is larger than another portion.

5. The light guiding device according to claim 1, wherein a second single-mode optical fiber having a larger mode field diameter than that of the first single-mode optical fiber is provided between the first single-mode optical fiber and the photonic crystal fiber.

6. The light guiding device according to claim 2, wherein a second single-mode optical fiber having a larger mode field diameter than that of the first single-mode optical fiber is provided between the first single-mode optical fiber and the photonic crystal fiber.

7. The light guiding device according to claim 3, wherein a second single-mode optical fiber having a larger mode field diameter than that of the first single-mode optical fiber is provided between the first single-mode optical fiber and the photonic crystal fiber.

8. The light guiding device according to claim 1, wherein a light of wavelength 490 nm or greater and 630 nm or less is used.

9. The light guiding device according to claim 2, wherein a light of wavelength 490 nm or greater and 630 nm or less is used.

10. The light guiding device according to claim 3, wherein a light of wavelength 490 nm or greater and 630 nm or less is used.

11. A light guiding method, comprising the steps of:
preparing a light guiding device in which a photonic crystal fiber, and a graded index fiber the refractive index of which in a direction of light concentration changes in a radial direction, are connected in this order at an emission-side end face of a first single-mode optical fiber; and
performing single mode conversion and making a mode field diameter uniform using the photonic crystal fiber for a plurality of light rays at different wavelengths guided by the first single-mode optical fiber, and emitting the plurality of light rays from the graded index fiber after performing chromatic aberration correction using the graded index fiber.
